(19) United States
(12) Patent Application Publication
(10) Pub. No.: US 2019/0036408 A1
(43) Pub. Date: Jan. 31, 2019

(54) MOTOR

(71) Applicant: Nidec Corporation, Kyoto (JP)

(72) Inventors: Yusuke IWAI, Kyoto (JP); Ryosuke ISHIDA, Kyoto (JP); Masakazu TANIKAWA, Kyoto (JP)

(21) Appl. No.: 16/006,884

(22) Filed: Jun. 13, 2018

(30) Foreign Application Priority Data
Jul. 28, 2017 (JP) 2017-146824

(51) Int. Cl. H02K 3/46; H02K 3/32; H02K 5/00

(52) U.S. Cl. CPC H02K 3/46; H02K 7/003; H02K 5/00; H02K 3/32

(57) ABSTRACT

A motor includes a rotor that is rotatable around a center axis, a stator that opposes the rotor, and a bracket. The bracket includes a cylindrical portion that accommodates the stator and that extends in an axial direction. The stator includes a stator core, an insulator that covers the stator core, a coil portion, and a terminal portion. The coil portion is formed from a conducting wire wound around the stator core via the insulator. The terminal portion is connected to a substrate, an end portion of the coil portion being bound on the terminal portion. The insulator includes a first protruding portion, at least a part of the first protruding portion protruding towards a radial-direction outer side than the cylindrical portion. Outside the cylindrical portion, the terminal portion is provided at the first protruding portion.

### CROSS REFERENCE TO RELATED APPLICATIONS

This application claims the benefit of priority to Japanese Patent Application No. 2017-146824 filed on Jul. 28, 2017. The entire contents of this application are hereby incorporated herein by reference.

### BACKGROUND OF THE INVENTION

### 1. Field of the Invention

The present disclosure relates to a motor.

### 2. Description of the Related Art

Hitherto, a motor in which a circuit board and a winding are electrically connected to each other by binding the wiring on a terminal pin that is connected to the circuit board is known. For example, Japanese Unexamined Patent Application Publication (Translation of PCT Application) No. 2008-538692 discloses a brushless DC motor in which one end portion of a stator mold assembly is covered by a bracket. In the brushless DC motor, a terminal of a driving coil is connected to a printed circuit board via the terminal pin.

However, in Japanese Unexamined Patent Application Publication (Translation of PCT Application) No. 2008-538692, as viewed from an axial direction, the terminal pin is provided on a radial-direction inner side of a cylindrical portion of the bracket. Therefore, in the radial direction, a space for providing the winding around a stator iron core is narrow.

### SUMMARY OF THE INVENTION

An exemplary motor of the present disclosure includes a rotor that is rotatable around a center axis, a stator that opposes the rotor, and a bracket. The bracket includes a cylindrical portion that accommodates the stator and that extends in an axial direction. The stator includes a stator core, an insulator that covers the stator core, a coil portion, and a terminal portion. The coil portion is formed from a conducting wire wound around the stator core via the insulator. The terminal portion is connected to a substrate, an end portion of the coil portion being bound on the terminal portion. The insulator includes a first protruding portion, at least a part of the first protruding portion protruding towards a radial-direction outer side than the cylindrical portion. Outside the cylindrical portion, the terminal portion is provided at the first protruding portion.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a sectional view of an exemplary structure of a motor.

FIG. 2 is a side view of the motor.

FIG. 3 is a perspective view of the motor.

FIG. 4 is a perspective view of another exemplary structure of the motor.

### DETAILED DESCRIPTION OF THE PREFERRED EMBODIMENTS

An exemplary embodiment of the present disclosure is described below with reference to the drawings.

In the specification, in a motor 100, a direction that is parallel to a center axis CA is called “axial direction”. In the axial direction, a direction towards a stator 2 (described later) from a substrate 24 (described later) is called “axial-direction upper side”. In the axial direction, a direction towards the substrate 24 from the stator 2 is called “axial-direction lower side”. In each structural element, an end portion on the axial-direction lower side is called “lower end portion”, and an end portion on the axial-direction upper side is called “upper end portion”. In addition, regarding surfaces of each structural element, the surface facing the axial-direction lower side is called “lower surface”, and the surface facing the axial-direction upper side is called “upper surface”.

A direction that is orthogonal to the center axis CA is called “radial direction”. A rotation direction around the center axis CA is called “peripheral direction”. In the radial direction, a direction towards the center axis CA is called “radial-direction inner side”, and a direction away from the center axis CA is called “radial-direction outer side”. In each structural element, an end portion on the radial-direction inner side is called “inner end portion”, and an end portion on the radial-direction outer side is called “outer end portion”. Regarding side surfaces of each structural element, the side surface facing the radial-direction inner side is called “inner side surface”, and the side surface facing the radial-direction outer side is called “outer side surface”.

The names of the above-described directions, end portions, surfaces, etc., do not indicate, for example, the positional relationships and directions when a motor* is actually installed in an apparatus.

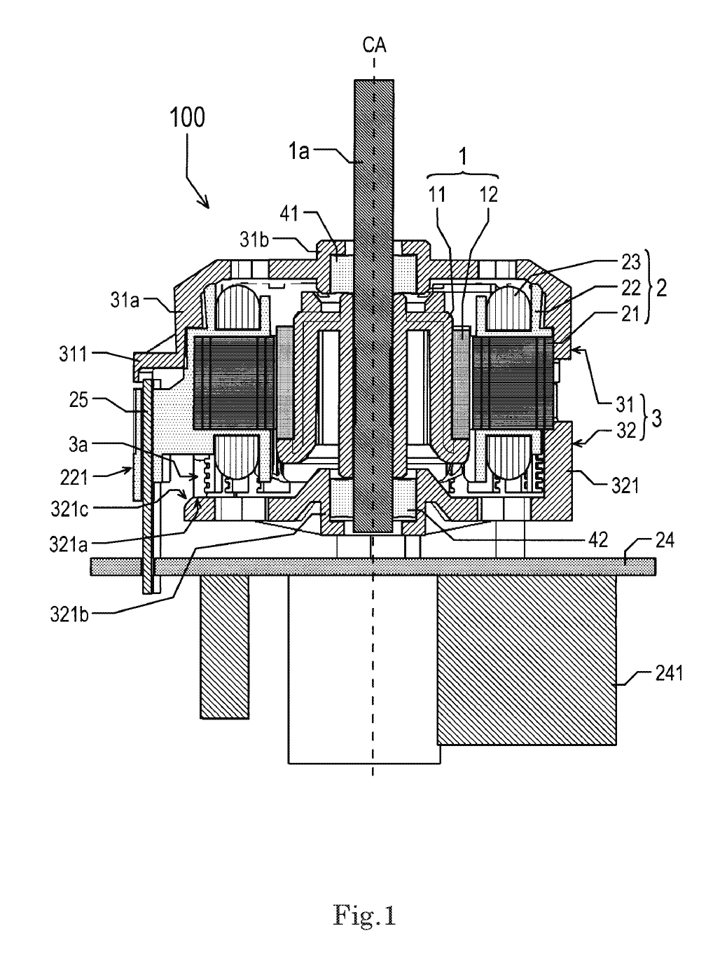

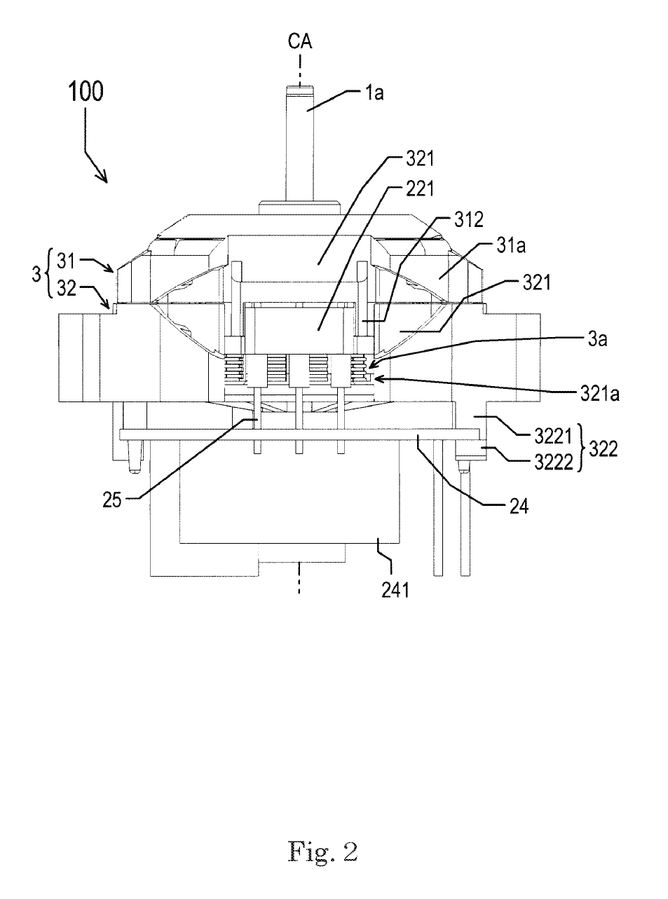

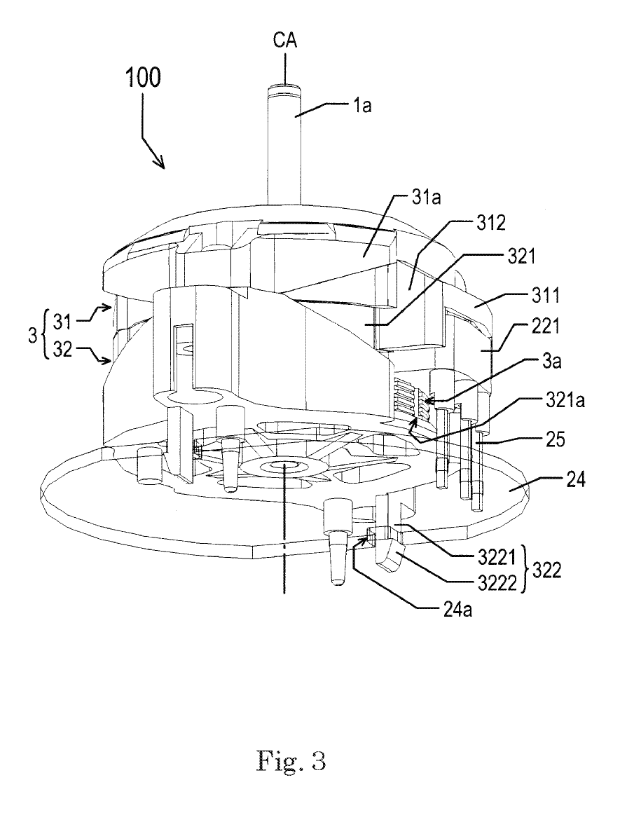

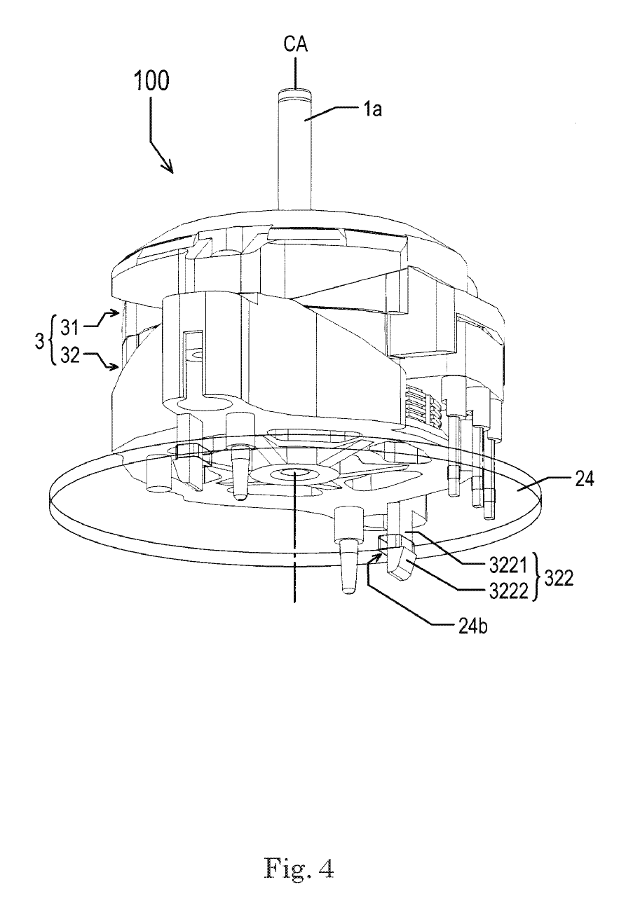

FIG. 1 is a sectional view of an exemplary structure of the motor 100. FIG. 2 is a side view of the motor 100. FIG. 3 is a perspective view of the motor 100. FIG. 1 shows a cross-sectional structure of the motor 100 including the center axis CA. For making it easier to view the structure, FIG. 3 shows the motor 100 with the substrate 24 being transparent, and does not show an electronic component 241 (described later). This similarly also applies to FIG. 4 described later.

As shown in FIG. 1, the motor 100 includes a shaft 1a, a rotor 1, the stator 2, a bracket 3, an upper bearing 41, and a lower bearing 42.

The shaft 1a is a rotary shaft that is mounted on the rotor 1, supports the rotor 1, and is rotatable around the center axis CA along with the rotor 1.

The rotor 1 is rotatable around the center axis CA extending in an up-down direction. The rotor 1 includes a holding member 11 and a magnet 12. The holding member 11 is a member that holds the magnet 12, and is mounted on the shaft 1a. The magnet 12 is positioned on the radial-direction inner side of the stator 2. The magnet 12 is held by the outer side surface of the holding member 11 and opposes the inner side surface of the stator 2 in the radial direction.

The stator 2 has a ring shape extending around the center axis CA, and opposes the rotor 1 in the radial direction. The stator 2 is accommodated in and held by the bracket 3. The stator 2 drives and rotates the rotor 1 when driving the motor 100. The stator 2 includes a stator core 21, an insulator 22, a plurality of coil portions 23, the substrate 24, and a terminal portion 25.

The stator core 21 is, for example, an iron-core member formed from a multi-layer steel plate in which electromagnetic steel plates are laminated to each other in the axial direction. The stator core 21 opposes the magnet 12 of the rotor 1 in the radial direction.

The insulator 22 is, for example, an insulating member using a resin material. The insulator 22 covers at least a part of the stator core 21. The insulator 22 includes a first protruding portion 221. At least a part of the first protruding portion 221 is connected to a recessed portion 321a of a cylindrical portion 321 (described later). The first protruding portion 221 protrudes towards the radial-direction outer side than the cylindrical portion 321 of the bracket 3.

The plurality of coil portions 23 are each formed from a conducting wire (not shown) wound around the stator core 21 via the insulator 22. End portions of each conducting wire are bound on the terminal portion 25.

The substrate 24 is positioned on the axial-direction lower side of the bracket 3. The substrate 24 is electrically connected to the conducting wires of the coil portions 23 via the terminal portion 25. The electronic component 241 including, for example, a driving device of the stator 2 is mounted on the lower surface of the substrate 24. The substrate 24 includes substrate recessed portions 24a. The substrate recessed portions 24a are, for example, cutout portions that are provided in an outer peripheral edge of the substrate 24. More specifically, the substrate recessed portions 24a are recessed towards the radial-direction inner side at the outer peripheral edge of the substrate 24, and extend through the substrate 24 in the axial direction. Although, in the embodiment, the number of substrate recessed portions 24a is two, it is not limited thereto. Any number of substrate recessed portions may be used as long as it is greater than or equal to the number of fixing portions 322 (described later) of the bracket 3.

The terminal portion 25 is connected to the substrate 24. Outside the cylindrical portion 321 of the bracket 3, the terminal portion 25 is provided at the first protruding portion 221. More specifically, the terminal portion 25 is provided at a portion of the first protruding portion 221 that is positioned at the outside of the cylindrical portion 321. Therefore, compared to when the terminal portion 25 is provided at the inside of the cylindrical portion 321 of the bracket 3, it is possible to increase the occupancy of each coil portion 23. For example, if the terminal portion 25 is provided at the inner portion of the cylindrical portion 321, a portion of the insulator 22 where the terminal portion 25 is disposed must have a large thickness in the radial direction. Therefore, the length in the radial direction of a portion of the insulator 22 where each conductor wire is wound is decreased, as a result of which the occupancy of each coil portion 23 is decreased. Therefore, the size of the stator core 21 in the radial direction and the size of the bracket 3 in the radial direction need to be large. In contrast, in the motor 100 of the embodiment, since the terminal portion 25 is provided at a portion that is located at the outside of the cylindrical portion 321, even if the size of the stator core 21 in the radial direction and the size of the bracket 3 in the radial direction are not large, it is possible to ensure sufficient space for providing the coil portions 23 on the stator core 21. As viewed from the axial direction, the electronic component 241 can be mounted on a region of the substrate 24 on the radial-direction inner side of the terminal portion 25. Therefore, compared to when the terminal portion 25 is provided at an inner portion of the bracket 3, it is possible to widen the region for mounting the electronic component 241. Further, since it is not necessary to mount the electronic component 241 by avoiding the location to which the terminal portion 25 is connected, it becomes easier to mount the electronic component 241 on the substrate 24.

The bracket 3 includes an upper bracket 31 and a lower bracket 32.

The upper bracket 31 is disposed above the lower bracket 32 in the axial direction. The upper bracket 31 includes an upper cylindrical portion 31a, an upper bearing holder 31b, a second protruding portion 311, and a wall portion 312. In other words, the bracket 3 includes the second protruding portion 311 and the wall portion 312.

The upper cylindrical portion 31a has a cylindrical shape extending in the axial direction. In the embodiment, the upper cylindrical portion 31a accommodates an upper portion of the rotor 1 and an upper portion of the stator 2.

The upper bearing holder 31b is disposed on the upper end portion of the upper cylindrical portion 31a, and holds the upper bearing 41 therein.

The second protruding portion 311 is disposed at the upper bracket 31. More specifically, the second protruding portion 311 protrudes towards the radial-direction outer side from the upper cylindrical portion 31a extending in the axial direction of the upper bracket 31. The second protruding portion 311 contacts the first protruding portion 221 in the axial direction. Therefore, the strength of the first protruding portion 221 protruding towards the radial-direction outer side can be reinforced by the second protruding portion 311. For example, in a step of binding the conducting wires of the coil portions 23 on the terminal portion 25 and when an external force acts upon the terminal portion 25, it is possible to increase the strength against a force that acts upon the first protruding portion 221.

The bracket 3 includes the wall portion 312 that is disposed on the radial-direction outer side of the cylindrical portion 321. The wall portion 312 is provided on at least one of end portions of the second protruding portion 311 in the peripheral direction, and extends in the axial direction. In the embodiment, the wall portion 312 is provided at the upper bracket 31. The wall portion 312 protrudes towards the radial-direction outer side from the upper cylindrical portion 31a. The wall portion 312 is connected to the second protruding portion 311, and extends in the axial direction. More specifically, the wall portion 312 extends towards the axial-direction lower side from the second protruding portion 311.

The wall portion 312 is disposed on the radial-direction outer side of the cylindrical portion 321. In the embodiment, the wall portion 312 is provided on both end portions of the second protruding portion 311 in the peripheral direction. However, the wall portion 312 is not limited thereto, and may be provided on one of the end portions of the second protruding portion 311 in the peripheral direction. When the wall portion 312 is provided, it is possible to increase the strength of the second protruding portion 311.

The wall portion 312 opposes the first protruding portion 221 in the peripheral direction. This makes it possible to, when assembling the motor 100, determine the peripheral-direction position of the insulator 22 including the first protruding portion 221 with respect to the bracket 3. Therefore, it is possible to position the stator core 21 in the peripheral direction.

Further, the wall portion 312 contacts a peripheral-direction side surface of the first protruding portion 221. This makes it difficult for the insulator 22 including the first protruding portion 221 to be displaced with respect to the bracket in the peripheral direction. Therefore, it is possible to suppress displacement of the stator core 21 in the peripheral direction.

The lower bracket 32 includes the cylindrical portion 321, the recessed portion 321a, a lower bearing holder 321b, a curved surface 321c, and the fixing portions 322. In other words, the bracket 3 includes the cylindrical portion 321 and the fixing portions 322, and the recessed portion 321a and the curved surface 321c.

The bracket 3 includes the cylindrical portion 321. The cylindrical portion 321 has a cylindrical shape that extends in the axial direction and that accommodates the stator 2. In the embodiment, the cylindrical portion 321 accommodates a lower portion of the rotor 1 and a lower portion of the stator 2.

The recessed portion 321a is recessed towards the axial-direction lower side at the upper end portion of the cylindrical portion 321, and extends through the cylindrical portion 321 of the bracket 3 in the radial direction. In the embodiment, the recessed portion 321a is provided at the upper end portion of the cylindrical portion 321 of the lower bracket 32. The first protruding portion 221 is disposed in the recessed portion 321a. More specifically, a part of the first protruding portion 221 protrudes towards the radial-direction outer side than the cylindrical portion 321 via the recessed portion 321a. This makes it possible for the first protruding portion 221 to easily protrude to the outside of the bracket 3.

In a region that overlaps the recessed portion 321a as viewed from the axial direction, a gap 3a is provided between the lower end portion of the first protruding portion 221 and the cylindrical portion 321. This makes it possible for the conducting wires of the coil portions 23 that are bound on the terminal portion 25 to be led out to the outside of the bracket 3 via the gap 3a.

In the region that overlaps the recessed portion 321a as viewed from the axial direction, the curved surface 321c is provided between the upper surface and the outer side surface of the cylindrical portion 321. The upper surface of the cylindrical portion 321 in this region is, in other words, a surface of the cylindrical portion 321 that faces the axial-direction upper side of the recessed portion 321a. In the embodiment, the curved surface 321c is a surface that protrudes towards the axial-direction upper side and the radial-direction outer side. However, other exemplifications are possible. In place of the curved surface 321c, a planar surface may be used. When a planar surface is provided, in the region that overlaps the recessed portion 321a as viewed from the axial direction, the upper end portion of the planar surface is connected to the upper surface of the cylindrical portion 321, and the lower end portion of the planar surface is connected to the outer side surface of the cylindrical portion 321. This makes it possible to easily lead out the conducting wires of the coil portions 23 that are bound on the terminal portion 25 to the outside of the bracket 3 along the curved surface 321c.

The lower bearing holder 321b is disposed at the lower end portion of the cylindrical portion 321 of the lower bracket 32, and holds the lower bearing 42 therein.

Each fixing portion 322 is positioned in the corresponding substrate recessed portion 24a and is fixed to the substrate 24. As mentioned above, each substrate recessed portion 24a is recessed towards the radial-direction inner side in a peripheral edge of the substrate 24. More specifically, each fixing portion 322 is fixed to the substrate 24 on the axial-direction lower side of the corresponding substrate recessed portion 24a via the corresponding substrate recessed portion 24a. Although, in the embodiment, the number of fixing portions 322 is three, the number of fixing portions 322 is not limited thereto and may be one or a plural number other than three. In order to further stabilize the fixing of the substrate 24 with respect to the bracket 3, the bracket 3 desirably includes a plurality of fixing portions 322.

Each fixing portion 322 includes a protrusion 3221 and a lug portion 3222.

Each protrusion 3221 is disposed in the corresponding substrate recessed portion 24a. More specifically, each protrusion 3221 extends towards the axial-direction lower side via the corresponding substrate recessed portion 24a.

Each lug portion 3222 extends in the peripheral direction from the corresponding protrusion 3221. Each lug portion 3222 is caught by the lower surface of the substrate 24. The upper surface of each lug portion 3222 contacts the lower surface of the substrate 24. This makes it possible to easily fix the substrate 24 to the bracket 3 by using the lug portions 3222 of the fixing portions 322.

The lug portion 3222 of each fixing portion 322 extends towards the same side in the peripheral direction from the corresponding protrusion 3221. This makes it possible to stabilize the balance of the stator 2 when rotating the rotor 1.

In the above-described embodiment, although the first protruding portion 221 protrudes to the outside of the cylindrical portion 321 via the recessed portion 321a that is provided in the cylindrical portion 321 of the lower bracket 32, the first protruding portion 221 is not limited thereto. The first protruding portion 221 may protrude to the outside of the cylindrical portion 321 via a recessed portion that is provided in the upper cylindrical portion 31a of the upper bracket 31. That is, the bracket 3 may include a recessed portion that is recessed towards the axial-direction upper side at the lower end portion of the upper bracket 31. As viewed from the axial direction, the recessed portion is provided at a location in the peripheral direction that corresponds to that of the recessed portion 321a, and extends through the upper bracket 31 in the radial direction. The first protruding portion 221 and the gap 3a on the axial-direction lower side of the first protruding portion 221 are provided in an opening that is formed by the recessed portion of the upper bracket 31 and the recessed portion 321a of the lower bracket 32. Even this makes it possible to easily protrude a part of the first protruding portion 221 to the outside of the bracket 3.

Although, in the above-described embodiment, the protrusion 3221 of each fixing portion 322 extends via the corresponding substrate recessed portion 24a, each protrusion 3221 is not limited thereto. As shown in FIG. 4, the protrusion 3221 of each fixing portion 322 may extend towards the axial-direction lower side via a through hole 24b other than the substrate recessed portion 24a. Each through hole 24b extends through the substrate 24 in the axial direction. That is, each fixing portion 322 may be positioned in the corresponding through hole 24b and fixed to the substrate 24. The protrusion 3221 of each fixing portion 322 is disposed in the corresponding through hole 24b.

According to the above-described embodiment, the motor 100 includes the rotor 1 that is rotatable around the center axis CA, the stator 2 that opposes the rotor 1, and the bracket 3 that includes the cylindrical portion 321 that accommodates the stator 2 and that extends in the axial direction. The stator 2 includes the stator core 21, the insulator 22 that covers the stator core, the coil portions 23, and the terminal portion 25. Each coil portion 23 is formed from a conducting wire wound around the stator core 21 via the insulator 22. The end portions of each coil portion 23 are bound on the terminal portion 25. The terminal portion 25 is connected to the substrate 24. The insulator 22 includes the first protruding portion 221, at least a part of the first protruding portion 221 protruding towards the radial-direction outer side than the cylindrical portion 321. Outside the cylindrical portion 321, the terminal portion 25 is provided at the first protruding portion 221.

According to the above-described embodiment, the bracket 3 includes the second protruding portion 311 that protrudes in the radial direction. The second protruding portion 311 contacts the first protruding portion 221 in the axial direction.

According to the above-described embodiment, the bracket 3 includes the wall portion 312 that is disposed on the radial-direction outer side of the cylindrical portion 321. The wall portion 312 is provided on at least one of the end portions of the second protruding portion 311 in the peripheral direction, and extends in the axial direction.

According to the above-described embodiment, the wall portion 312 opposes the first protruding portion 221 in the peripheral direction.

According to the above-described embodiment, the wall portion 312 contacts a side surface of the first protruding portion 221 in the peripheral direction.

According to the above-described embodiment, the bracket 3 includes the lower bracket 32 including the cylindrical portion 321, and the upper bracket 31 that is disposed on the axial-direction upper side of the lower bracket 32. The second protruding portion 311 is disposed at the upper bracket 31.

At the upper end portion of the cylindrical portion 321, the bracket 3 includes the recessed portion 321a that is recessed towards the axial-direction lower side. The first protruding portion 221 is disposed in the recessed portion 321a.

According to the above-described embodiment, in a region that overlaps the recessed portion 321a as viewed from the axial direction, the gap 3a is provided between the lower end portion of the first protruding portion 221 and the cylindrical portion 321.

According to the above-described embodiment, in the region that overlaps the recessed portion 321a as viewed from the axial direction, the curved surface 321c that protrudes towards the axial-direction upper side and the radial-direction outer side is provided between the upper surface and the outer side surface of the cylindrical portion 321.

According to the above-described embodiment, the motor 100 further includes the substrate 24. The bracket 3 includes the fixing portions 322. Each fixing portion 322 is positioned in one of the substrate recessed portion 24a that is recessed towards the radial-direction inner side from the peripheral edge of the substrate 24 and the through hole 24b that is provided in the substrate 24, and is fixed to the substrate 24.

Each fixing portion 322 includes the protrusion 3221 that extends towards the axial-direction lower side and the lug portion 3222 that extends from the corresponding protrusion 3221 and that is caught by the lower surface of the substrate 24.

According to the above-described embodiment, the bracket 3 includes a plurality of fixing portions 322. The lug portion 3222 of each fixing portion 322 extends towards the same side in the peripheral direction from the corresponding protrusion 3221.

In the embodiment, the present disclosure is applied to the motor 100 of an inner-rotor type. However, the present disclosure is not limited thereto. For example, the present disclosure may be applied to a motor of an outer-rotor type. In the embodiment, the shaft 1a is a rotary shaft that is mounted on the rotor 1. However, the shaft 1a is not limited thereto. The shaft 1a may be a fixed shaft that is mounted on the stator 2. When the shaft 1a is a fixed shaft, a bearing (not shown) is provided at the rotor 1 between it and the shaft 1a.

The present disclosure is useful for a motor including a terminal portion that is connected to a substrate, conducting wires of coil portions being bound thereon.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A motor comprising:
a rotor that is rotatable around a center axis;
a stator that opposes the rotor; and
a bracket that includes a cylindrical portion that accommodates the stator and that extends in an axial direction,
wherein the stator includes
a stator core,
an insulator that covers the stator core,
a coil portion that is formed from a conducting wire wound around the stator core via the insulator, and
a terminal portion that is connected to a substrate, an end portion of the coil portion being bound on the terminal portion,
wherein the insulator includes a first protruding portion, at least a part of the first protruding portion protruding towards a radial-direction outer side than the cylindrical portion, and
wherein outside the cylindrical portion, the terminal portion is provided at the first protruding portion.

2. The motor according to claim 1,
wherein the bracket includes a second protruding portion that protrudes in a radial direction, and
wherein the second protruding portion contacts the first protruding portion in the axial direction.

3. The motor according to claim 2,
wherein the bracket includes a wall portion that is disposed on the radial-direction outer side of the cylindrical portion, and
wherein the wall portion is provided on at least one of end portions of the second protruding portion in a peripheral direction, and extends in the axial direction.

4. The motor according to claim 3,
wherein the wall portion opposes the first protruding portion in the peripheral direction.

5. The motor according to claim 4,
wherein the wall portion contacts a side surface of the first protruding portion in the peripheral direction.

6. The motor according to claim 2,
wherein the bracket includes
a lower bracket that includes the cylindrical portion, and
an upper bracket that is disposed on an axial-direction upper side of the lower bracket, and
wherein the second protruding portion is disposed at the upper bracket.

7. The motor according to claim 1,
wherein at an upper end portion of the cylindrical portion, the bracket includes a recessed portion that is recessed towards an axial-direction lower side, and
wherein the first protruding portion is disposed in the recessed portion.

8. The motor according to claim 7,
wherein in a region that overlaps the recessed portion as viewed from the axial direction, a gap is provided between a lower end portion of the first protruding portion and the cylindrical portion.

9. The motor according to claim 8,
wherein in the region that overlaps the recessed portion as viewed from the axial direction, a curved surface that protrudes towards an axial-direction upper side and the radial-direction outer side is provided between an upper surface and an outer side surface of the cylindrical portion.

10. The motor according to claim 1, further comprising the substrate,
wherein the bracket includes a fixing portion, and
wherein the fixing portion is positioned in one of a through hole that is provided in the substrate and a substrate recessed portion that is recessed towards a radial-direction inner side from a peripheral edge of the substrate, and is fixed to the substrate.

11. The motor according to claim 10,
wherein the fixing portion includes
a protrusion that extends towards an axial-direction lower side, and
a lug portion that extends from the protrusion and that is caught by a lower surface of the substrate.

12. The motor according to claim 11,
wherein the bracket includes a plurality of the fixing portions, and
wherein the lug portion of each fixing portion extends towards a same side in a peripheral direction from a corresponding one of the protrusions.
